(19) United States
(12) Patent Application Publication
(10) Pub. No.: US 2026/0043147 A1
(43) Pub. Date: Feb. 12, 2026

(54) Polyethyleneamine Alkoxylate Corrosion Inhibitors

(71) Applicant: Indorama Ventures Oxides LLC, The Woodlands, TX (US)

(72) Inventors: John CLEMENTS, The Woodlands, TX (US); Luis SALAZAR, The Woodlands, TX (US); Jay RIETHMEYER, The Woodlands, TX (US)

(21) Appl. No.: 19/100,883

(22) PCT Filed: Jul. 24, 2023
(86) PCT No.: PCT/US2023/028496

§ 371 Date: Feb. 3, 2025

Related U.S. Application Data
(60) Provisional application No. 63/394,732, filed on Aug. 3, 2022.

(51) Int. Cl. C23F 11/173; C08G 73/02

(52) U.S. Cl. CPC C23F 11/173; C08G 73/024

(57) ABSTRACT

The present disclosure relates to a corrosion inhibitor composition including a polyethyleneamine alkoxylate and to the use of the corrosion inhibitor composition to treat corrosive water sources and to inhibit the corrosion of various metal surfaces in contact with the corrosive water sources by contacting the metal surface or a portion thereof with the composition.

### CROSS-REFERENCE TO RELATED APPLICATION

This application claims the benefit of U.S. Provisional Patent Application Ser. No. 63/394,732 filed Aug. 3, 2022. The content of the aforementioned application is incorporated herein by reference.

### FIELD

The present disclosure is generally directed to corrosion inhibitor compositions, processes for preparing such corrosion inhibitor compositions, and methods for inhibiting corrosion of metal substrates using such corrosion inhibitor compositions.

### BACKGROUND

Production equipment used in various technologies, such as piping, pumps, and motors, is typically made of metals and metal alloys and requires maintenance to continue to function properly. In the course of operation, this equipment is often exposed to acidic or otherwise corrosive environments, especially in oil and gas operations. Exposure to acidic environments gradually wears away and destroys metallic surfaces, which ultimately can cause them to fail.

To mitigate corrosion issues, corrosion inhibitors are often used. Conventional corrosion inhibitors include, for example, condensation products of fatty acids and diethylene triamine (DETA) (see US 2009/0181867), alkyl phosphonic acids (see WO 2015/104308), and polyethyleneamines (see U.S. Pat. No. 7,468,158). Broadly, conventional corrosion inhibitors operate by forming a protective layer on a metal substrate. The protective layer physically prevents corrosive chemicals, such as acids, from penetrating the metal surface. In some instances, conventional corrosion inhibitors have been found to suffer from performance problems, especially when utilized at higher temperatures and/or acidic environments. It would be desirable to develop new corrosion inhibitor compositions which can improve the corrosion inhibition efficacy beyond that of conventional corrosion inhibitor compositions.

### SUMMARY

The present disclosure provides a corrosion inhibitor composition including a polyethyleneamine alkoxylate. In some embodiments, the corrosion inhibitor composition further includes at least one solvent, additive or mixture thereof.

In another embodiment, the present disclosure provides a treated water source including the corrosion inhibitor composition and a water source and to a method of forming the treated water source by adding the corrosion inhibitor composition to the water source.

Also provided is a treated metal containment including a metal containment and the treated water source disposed within the metal containment and in contact with a surface of the metal containment or a portion of the surface.

Finally, there is provided a method of inhibiting corrosion of a metal containment by contacting a surface of the metal containment surface or a portion of the surface with the treated water source.

### BRIEF DESCRIPTION OF THE DRAWINGS

FIG. 1 is a graph of the corrosion rate as a function of time of various corrosion inhibitors at a dosage level of 2000 ppm; and

FIG. 2 is a graph of the corrosion rate as a function of time of various corrosion inhibitors at a dosage level of 2000 ppm.

### DETAILED DESCRIPTION

The following terms shall have the following meanings:

The term “comprising” and derivatives thereof are not intended to exclude the presence of any additional component, step, or procedure, whether or not the same is disclosed herein. To avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step, or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e., to at least one) of the grammatical objects of the article. By way of example, “an amine” means one amine or more than one amine. The phrases “in one embodiment”, “according to one embodiment” and the like generally mean the particular feature, structure, or characteristic following the phrase is included in at least one embodiment of the present disclosure and may be included in more than one embodiment of the present disclosure. Importantly, such phrases do not necessarily refer to the same aspect. If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the present disclosure.

The term “water source” refers to a liquid comprising water and one or more corrodents. In some embodiments, the water source is water used in or wastewater from one or more industrial processes. In another embodiment, the water source is produced water. In some embodiments, the amount of the one or more corrodents in the water source is sufficient to corrode carbon steel at a rate of at least 100 milli-inches per year, and in other embodiments as much as 1000 milli-inches per year.

The term “produced water” refers to a water source that flows from a subterranean formation in a hydrocarbon recovery process, such as hydraulic fracturing or tertiary oil recovery, further where the water source includes one or more hydrocarbons, one or more dissolved solids, or a combination thereof. Natural gas and condensates, such as hydrocarbons of intermediate length may also be present.

The term “corrodent(s)” refers to salts and/or other dissolved solids, liquids, or gasses that cause, accelerate, or promote corrosion, further where the corrodent is dissolved or dispersed in a water source. Non-limiting examples of corrodents include hydrogen sulfide, hydrogen chloride, carbon dioxide, oxygen, sodium chloride, calcium chloride, and/or sulfur dioxide. Other corrodents may include metal cations, metal complexes such as aqueous metal cations, metal chelates and/or organometallic complexes, aluminum ions, ammonium ions, barium ions, chromium ions, cobalt ions, cuprous ions, cupric ions, calcium ions, ferrous ions, ferric ions, magnesium ions, manganese ions, molybdenum ions, nickel ions, potassium ions, strontium ions, titanium ions, uranium ions, vanadium ions, zinc ions, bromide ions, carbonate ions, chlorate ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, hydrogen sulfite ions, carbonic acid, hydrochloric acid, nitric acid, sulfuric acid, nitrous acid, sulfurous acid, peroxy acids, phosphoric acid, ammonia, bromine, chlorine, chlorine dioxide, fluorine, hydrogen chloride, hydrogen sulfide, iodine, nitrogen dioxide, nitrogen monoxide, ozone, hydrogen peroxide, polysaccharide, or combinations thereof.

The term “metal containment” refers to a structural element for containing a water source. In some embodiments, the metal containment may be in fluid communication with one or more devices or apparatuses.

“Metal” includes elements conventionally known as metals as well as admixtures and alloys containing different metals. A metal may exhibit a crystal structure such as a body-centered cubic (bcc), face-centered cubic (fck), and hexagonal close-packed (hep) structure. An “alloy” is a mixture of two or more elements in which the main component is a usually a metal. Alloys include ferrous metals and alloys of iron such as steel, stainless steel, cast iron, tool steel, and alloy steel. Iron alloyed with various proportions of carbon gives low, mid and high carbon steels, with increasing carbon levels reducing ductility and toughness. The addition of silicon produces cast irons, while the addition of chromium, nickel and molybdenum to carbon steels results in stainless steels. Alloys of aluminum, titanium and magnesium may be preferred for their high strength-to-weight ratios.

Steel includes all types of steel, including low carbon or mild steels, medium carbon steels, and high carbon steels. Carbon steels composed only of iron and carbon are included as well as alloy steels such as a steel containing one or more of manganese, silicon, nickel, titanium, copper, chromium or aluminum. Stainless steels that contain chromium as a main alloying element, for example, that contain greater than 10-20% by weight chromium, are included. Stainless steels can be divided into three groups based on their crystalline structure austenitic steels, which are non-magnetic and non-heat-treatable and which generally contain chromium, nickel, and carbon; ferritic steels that contain trace amounts of nickel, chromium, carbon along with other alloying elements such as molybdenum, aluminum and/or titanium; and martensitic steels.

The term “substantially free” refers to a composition in which a particular compound or moiety is present in an amount that has no material effect on the composition. In some embodiments, “substantially free” may refer to a composition in which the particular compound or moiety is present in the composition in an amount of less than 2% by weight, or less than 1% by weight, or less than 0.5% by weight, or less than 0.1% by weight, or less than 0.05% by weight, or even less than 0.01% by weight based on the total weight of the composition, or that no amount of that particular compound or moiety is present in the respective composition.

Where substituent groups are specified by their conventional chemical formula, written from left to right, they equally encompass the chemically identical substituents that would result from writing the structure from right to left, for example, —CH₂O— is equivalent to —OCH₂—.

The term “optional” or “optionally” means that the subsequently described event or circumstance may or may not occur, and that the description includes instances where said event or circumstance occurs and instances where it does not.

The present disclosure is generally directed to a corrosion inhibitor composition comprising a polyethyleneamine alkoxylate having a general formula (I)

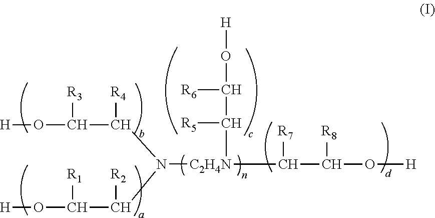

where R₁ and R₂ are each independently hydrogen, or methyl with the proviso that at least one of R₁ or R₂ is hydrogen and each R₁ and R₂ is independently selected in each —O—CHR₁—CHR₂— unit;
R₃ and R₄ are each independently hydrogen, or methyl with the proviso that at least one of R₃ or R₄ is hydrogen and each R₃ and R₄ is independently selected in each —O—CHR₃—CHR₄— unit;
R₅ and R₆ are each independently hydrogen, or methyl with the proviso that at least one of R₅ or R₆ is hydrogen and each R₅ and R₆ is independently selected in each —O—CHR₅—CHR₆— unit;
R₇ and R₈ are each independently hydrogen, or methyl with the proviso that at least one of R₇ or R₈ is hydrogen and each R₇ and R₈ is independently selected in each —O—CHR₇—CHR₈—
a, b, c, and d are each independently integers on average of about 15 or less with the proviso that a+b+c+d is on average at least about 30 and less than about 49; and
n is an integer from about 1 to about 10. Accordingly, the above polyethyleneamine alkoxyalates of formula (I) may include, without limitation, homopolymers, and both random and block co-polymers of any one or more of the following (either alone or mixed with one another in any proportion): oxyethylene units and oxypropylene units.

Thus, in one embodiment the amount of oxyethylene units present in the polyethyleneamine alkoxylate of formula (I) may be at least about 1% by weight, based on the total weight of oxyethylene units and oxypropylene units. In another embodiment, the amount of oxyethylene units present in the polyethyleneamine alkoxylate of formula (I) may be at least about 5% by weight, or at least about 10% by weight, or at least about 20% by weight, or at least about 30% by weight, or at least 40% by weight, or at least 50% by weight, or at least 60% by weight, or at least 70% by weight, or at least 80% by weight or at least 90% by weight based on the total weight of oxyethylene units and oxypropylene units. In still another embodiment, the amount of oxyethylene units present in the polyethyleneamine alkoxylate of formula (I) may range from at least about 1% by weight to about 99% by weight, or from at least about 10% by weight to about 90% by weight, or from at least about 15% by weight to about 85% by weight, or from at least about 25% by weight to about 75% by weight, or from at least about 35% by weight to about 65% by weight, or from at least about 45% by weight to about 55% by weight, based on the total weight of oxyethylene units and oxypropylene units In a further embodiment, each of R₁-R₈ are hydrogen.

In yet another embodiment, the amount of oxypropylene units present in the polyethyleneamine alkoxylate of formula (I) may be at least about 1% by weight, based on the total weight of oxyethylene units and oxypropylene units. In another embodiment, the amount of oxypropylene units present in the polyethyleneamine alkoxylate of formula (I) may be at least about 5% by weight, or at least about 10% by weight, or at least about 20% by weight, or at least about 30% by weight, or at least about 40% by weight, or at least about 50% by weight, or at least about 60% by weight, or at least about 70% by weight, or at least about 80% by weight or at least about 90% by weight based on the total weight of oxyethylene units and oxypropylene units. In a further embodiment, each of R₁-R₈ are methyl.

In another embodiment, the weight ratio of oxyethylene units to oxypropylene units in the polyethyleneamine alkoxylate is about 1/99 to about 99/1 or about 10/90 to about 90/10 or about 25/75 to about 75/25 or about 35/65 to about 65/35 or about 45/55 to about 55/45.

In another embodiment, n is an integer from about 1 to about 8, or from about 2 to about 6, or from about 3 to about 5.

In yet another embodiment, a+b+c+d on average is at least about 32 to about 48, or at least about 35 to about 47, or at least about 36 to about 45, or at least about 37 to about 43, or at least about 38 to about 42.

The polyethyleneamine alkoxylate of formula (I) may be prepared by adding ethylene oxide and/or propylene oxide to a polyethyleneamine having a general formula H₂N—(C₂H₄—NH)ₙ—H where n is defined above. Examples of polyethyleneamines include, but are not limited to, ethylenediamine, diethylenetriamine, triethylenetetramine, tetraethylenepentamine, and pentaethylenehexamine. The polyethyleneamines may be prepared by the reaction of an alkylene dichloride (e.g., ethylene-1,2-dichloride) with ammonia, followed by fractional distillation. These compounds or mixtures of compounds may further comprise small amounts of reaction by-products, including cyclic amines, particularly piperazines, and cyclic amines with nitrogen-containing side chains. Mixtures of different polyethyleneamines may be used. Preparation of polyalkyleneamines is described for example, in U.S. Pat. No. 2,792,372 to Dickson.

In one embodiment, ethylene oxide and/or propylene oxide may be contacted with the starting polyethyleneamine in an alkoxylation reaction zone for a period of time sufficient to form the alkoxylate. In one embodiment, an average of at least 30 to less than 50 alkylene oxides (i.e., ethylene oxide and propylene oxide) are contacted with one active hydrogen atom of the starting polyethyleneamine. That is, an average of at least about 30 moles to less than 50 moles of alkylene oxide is added per mole of active hydrogen contained in the starting polyethyleneamine. The period of time the polyethyleneamine is contacted with the ethylene oxide and/or propylene oxide is a period of time sufficient to form the alkoxylate and in some instances may range from about 0.5 hours to about 24 hours.

The alkoxylation reaction zone can be a closed reaction vessel with alkoxylation being carried out under elevated temperature and pressure and in the presence of a base catalyst. For example, alkoxylation may be conducted at a temperature ranging from about 50° C. to about 150° C. and at a pressure ranging from about 40 psi to about 100 psi. The base catalyst may be any alkaline compound customarily used for base-catalyzed reactions, for example, an alkali metal hydroxide such as sodium hydroxide, lithium hydroxide, potassium hydroxide, or cesium hydroxide, or a tertiary amine, such as dimethyl cyclohexylamine or 1,1,3,3-tetramethylguanidine. After alkoxylation, the resulting product may be vacuum stripped to remove any unnecessary components, such as excess unreacted alkylene oxide, water and/or base catalyst, while leaving the resulting polyethyleneamine alkoxylate.

As described above, the polyethyleneamine alkoxylates include polyethyleneamine ethylene oxide homopolymers, polyethyleneamine propylene oxide homopolymers, and polyethyleneamine ethylene oxide-propylene oxide co-polymers. The ethylene oxide-propylene oxide co-polymers of polyethyleneamine may be obtained by adding ethylene oxide and propylene oxide to the polyethyleneamine. The addition order and addition form of ethylene oxide and propylene oxide (i.e., in block sequence or random sequence) with respect to the polyethyleneamine is optional.

In one embodiment, the polyethyleneamine alkoxylate is used neat (i.e., the corrosion inhibitor composition consists of, or consists essentially of the polyethyleneamine alkoxylate). In other embodiments, the corrosion inhibitor composition includes the polyethyleneamine alkoxylate and at least one of a solvent or an additive. In such embodiments, the amount of polyethyleneamine alkoxylate present in the corrosion inhibitor composition may be at least about 0.01% by weight and up to about 99.9% by weight, for example about 1% by weight and up to about 95% by weight, or about 2% by weight and up to about 85% by weight, or about 5% by weight and up to about 75% by weight, or about 10% by weight and up to about 65% by weight, or about 20% by weight and up to about 55% by weight or about 25% by weight and up to about 50% by weight, or about 30% by weight and up to about 45% by weight, based on the total weight of the corrosion inhibitor composition.

The solvent may be a compound that does not react with the polyethyleneamine alkoxylate to form any covalent bonds, and is substantially liquid at temperatures, for example within the range of 0° C. to about 100° C. and at atmospheric pressure. Examples of solvents include, but are not limited to, water (for e.g., municipal water, brine, brackish water, produced water), C₁-C₆ alkanols, alkoxyalkanols, glycols, and mixtures of two or more such solvents in any ratio. Alkanols include, but are not limited to, ethanol, n-propanol, isopropanol, scc-butanol, isobutanol, t-butanol and amyl alcohol. Examples of alkoxyalkanols include, but are not limited to, 2-methoxyethanol, 3-methoxybutanol, 2-ethoxyethanol, 2-propoxyethanol, 2-butoxyethanol, 1-methoxy-2-propanol, 1-ethoxy-2-propanol, and 1-propoxy. Examples include 2-propanol, 1-butoxy-2-propanol, 1-tert-butoxy-2-propanol, 3-methyl-3-methoxybutanol, and 1-methoxy-2-butanol. Examples of glycols include, but are not limited to, ethylene glycol, propylene glycol, 1,3-propanediol, 1,2-butylene glycol, 1,3-butylene glycol, 1,4-butanediol, 2-methyl-1,3-propanediol, neopentyl glycol, glycerol, trimethylolpropane, 3-methyl-1,5-pentanediol, 1,4-cyclohexanedimethanol, diethylene glycol, tetraethylene glycol, dipropylene glycol, triethylene glycol, tripropylene glycol, polyethylene glycol, polypropylene glycol, erythritol, pentaerythritol, sorbitol, and block or random copolymer glycols of ethylene oxide and propylene oxide.

The amount of solvent present in the corrosion inhibitor composition may be at least about 0.1% by weight and up to about 99.99% by weight, or at least about 10% by weight and up to about 90% by weight, or at least about 20% by weight and up to about 80% by weight, or at least about 30% by weight and up to about 70% by weight, or at least about 40% by weight and up to about 60% by weight, or least about 45% by weight and up to about 55% by weight, based on the total weight of the corrosion inhibitor composition.

The additives may include, but are not limited to, a surfactant (for e.g., anionic surfactants including alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and monoalkyl and dialkyl sulfosuccinates and sulfosuccinamates; cationic surfactants including alkyl trimethyl quaternary ammonium salts, alkyl dimethyl benzyl quaternary ammonium salts, dialkyl dimethyl quaternary ammonium salts, and imidazolinium salts; nonionic surfactants including alcohol alkoxylates, alkylphenol alkoxylates, block copolymers of ethylene, propylene and/or butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkyl polyethylene glycol esters and diesters; betaines and sultanes, amphoteric surfactants such as alkyl and amphoacetates and amphodiacetates, alkyl amphopropripionates amphodipropionates, and alkyliminodiproprionate), pH-adjusting agent, oxygen scavenger, preservative, scale inhibitor, wetting agent, dispersant, binding agent, weighting agent, emulsion breaker, foamer/defoamer, buffer, water clarifier, salt, proppant particulates, diverting agent, fluid loss control additive, gas, nitrogen, carbon dioxide, surface modifying agent, tackifying agent, catalyst, clay control agent, biocide, friction reducer, bridging agent, flocculant, H₂S scavenger, CO₂ scavenger, lubricant, relative permeability modifier, resin, coating enhancement agent, filter cake removal agent, and mixtures thereof.

The amount of additive(s) present in the corrosion inhibitor composition may be at least about 0.1% by weight and up to about 40% by weight, or at least about 1% by weight and up to about 25% by weight, or at least about 5% by weight and up to about 20% by weight, or at least about 10% by weight and up to about 20% by weight, based on the total weight of the corrosion inhibitor composition.

According to another embodiment, there is provided a treated water source comprising a water source and the corrosion inhibitor composition comprising the polyethyleneamine alkoxylate of formula (I). In one embodiment, the water source is a continuously flowing water source, such as produced water flowing from a subterranean reservoir and into or through a pipe or tank, wastewater isolated from a continuous manufacturing process flowing into a wastewater treatment apparatus or water flowing in a continuous manufacturing process. In other embodiments, the water source is a batch, or plug, substantially disposed in a batchwise or static state within a metal containment.

In one embodiment, the pH of the water source may be less than 7. In some embodiments, the pH of the water source is between about 1 and about 6, or between 5 and 6, or between 4 and 5, or between 3 and 4, or between 2 and 3, or between 1 and 2, or between 0 and 1. In other embodiments, the pH of the water source is between 7 and 14. In still other embodiments, the pH of the water source is between 8 and 14, or between 9 and 14, or between 10 and 14, or between 11 and 14, or between 12 and 14, or between 13 and 14. In still other embodiments, the pH of the water source is between 7 and 8, or between 7 and 9, or between 7 and 10, or between 7 and 11, or between 7 and 12. In further embodiments, the pH of the water source is between 7 and 13, or between 8 and 13, or between 9 and 12, or between 10 and 11.

In some embodiments, the water source is selected from produced water; injectate; connate; industrial wastewater; an aqueous mixture comprising sodium hydroxide and sodium sulfide (“white liquor”); an aqueous mixture comprising lignin, one or more carbohydrates, sodium carbonate, sodium sulfate, and/or one or more other salts (“black liquor”); municipal wastewater; treated or partially treated wastewater; sea water; and a mixture thereof. In other embodiments, the water source may include one or more salts, ions, buffers, acids, bases, surfactants, or other dissolved, dispersed, or emulsified compounds, materials, components, or combinations thereof. In still other embodiments, the water source includes about 0% by weight to about 35% by weight total dissolved solids. In some such embodiments, the total dissolved solids are substantially non-polymeric solids. In some such embodiments, the dissolved solids comprise, consist of, or consist essentially of ionic compounds.

In still other embodiments, the water source includes one or more polymers, surfactants, scale inhibitors, stabilizers, metal chelating agents, conventional corrosion inhibitors, or paraffin inhibitors as determined by the operator in a subterranean hydrocarbon recovery process or other industrial process. In embodiments where an injectate comprises produced water, the injectate is also termed “recycled produced water.” In some embodiments, the water source further comprises minor amounts (<50% by weight) of residual hydrocarbon products entrained therein. In some embodiments, the water source additionally comprises one or more solvents, coupling agents, emulsifying agents (emulsifiers), demulsifying agents (demulsifiers), paraffin wax inhibitors, and mixtures thereof.

In other embodiments, the water source is effluent from mining or paper production. In some embodiments, the water source is a high total dissolved solids (about 5% by weight or more dissolved non-polymeric solids) water source; a high temperature (temperature in excess of about 60° C. and as high as about 200° C.) water source; or a high total dissolved solids, high temperature water source. In some embodiments where the water source includes high total dissolved solids, a substantial portion of the total dissolved solids (that is, more than 50% by weight) are ionic compounds.

In some embodiments, the treated water source includes a total polyethyleneamine alkoxylate concentration, by weight, of at least about 50 ppm, or at least about 100 ppm, or at least about 250 ppm, or at least about 500 ppm, or at least about 750 ppm, or at least about 1000 ppm, or at least about 1250 ppm, or at least about 1500 ppm, or at least about 1750 ppm, or at least about 2000 ppm, or at least 3000 ppm, or at least about 5000 ppm. In other embodiments, the total polyethyleneamine alkoxylate concentration, by weight, present in the treated water source is less than about 10,000 ppm, or less than about 7500 ppm, or less than about 5000 ppm, or less than about 3000 ppm, or less than about 2500 ppm, or less than about 2250 ppm, or less than about 2000 ppm. In yet another embodiment, the total polyethyleneamine alkoxylate concentration, by weight, present in the treated water source is from about 50 ppm to about 5000 ppm, or from about 100 ppm to about 4000 ppm, or from about 500 ppm to about 3000 ppm, or from about 1000 ppm to about 2000 ppm. In other embodiments, the foregoing amounts are provided by volume and not by weight.

In another embodiment, there is provided a method of forming a treated water source including adding the corrosion inhibitor composition to a water source.

In still other embodiments, there is provided a treated metal containment comprising the treated water source. In other words, the treated metal containment is a metal containment comprising a treated water source. In particular, the treated water source is disposed within the metal containment and in contact with a surface of the metal containment or a portion of the surface. In some embodiments, the metal containment is a tank, pipe, or other apparatus having a metal surface or portion of the surface in contact with a treated water source. In some embodiments the metal containment is enclosed. In other embodiments the metal containment is exposed to the environment or is in fluid communication with one or more other devices or metal containments, or both exposed to the environment and in fluid communication with one or more other devices or metal containments.

At any point in the storage, conveyance, treatment, discharge, disposal, or any other process in which a water source is contacted with a metal containment surface, the corrosion inhibitor composition containing the polyethyleneamine alkoxylate of formula (I) which is present in at the total concentrations described herein is advantageously applied to or contacted with the water source to inhibit corrosion of the metal containment surface.

In some embodiments, the metal containment is any type of metal containment comprising one or more metal surfaces for contacting a water source containing one or more corrodents. In one embodiment, the metal containment or a surface thereof comprises, consists of, or consists essentially of steel. In some embodiments, the steel comprises, consists of, or consists essentially of carbon steel. In some embodiments, the metal containment or a surface thereof comprises, consists of, or consists essentially of iron. In some embodiments, the metal containment or a surface thereof comprises, consists of or consists essentially of aluminum, zinc, chromium, manganese, nickel, tungsten, molybdenum, titanium, vanadium, cobalt, niobium, copper, or mixtures thereof.

In an embodiment, the metal containment or a surface thereof comprises, consists of, or consists essentially of metal and one or more of boron, phosphorus, sulfur, silicon, oxygen, nitrogen, and/or mixtures thereof. In some embodiments, the metal containment comprises, consists of, or consists essentially of a pipe. In some embodiments, the pipe is coiled tubing. In some embodiments, the pipe has a device attached thereto, the device or a surface thereof comprising, consisting of, or consisting essentially of metal. In some embodiments the device is a pressure gauge, a flowmeter, a chemical sensor, or a pump. In some embodiments, the metal containment comprises, consists of, or consists essentially of a tank. In some embodiments, the tank is enclosed and thus the contents of the tank are not open to the atmosphere. In some embodiments, the contents of the enclosed tank are at a pressure that is higher than the ambient environmental air pressure. In some embodiments, the contents of the sealed tank are at a pressure that is lower than the ambient environmental air pressure external to the tank. In some embodiments, the tank is open to the air and the contents are at ambient environmental air pressure. In some embodiments, the tank has an inflow and/or an outflow pipe attached thereto. In some embodiments, the tank has a device attached thereto, such as a pump, flowmeter, chemical sensor, pressure gauge, or metal drill pipe. In some embodiments, the metal containment is a railroad tank car. In some embodiments, the metal containment is a tank truck, sometimes known as a tanker.

In other embodiments, the metal containment is a separation vessel, dehydration unit, gas line, pipeline, cooling water system, valve, spool, fitting (e.g., such as those that make up a well Christmas tree), treating tank, coil of a heat exchanger, fractionating column, cracking unit, pump parts (e.g., parts of beam pumps), as well as downhole surfaces that may be impacted by corrosion from the water source, such as those pipes, pump parts such as sucker rods, electrical submersible pumps, screens and the like, which are positioned in a wellbore during production.

In another embodiment, a method of inhibiting corrosion of a metal containment surface comprises, consists of, or consists essentially of applying or adding the corrosion inhibitor composition to one or more water sources to form a treated water source, and contacting the metal containment surface or a portion thereof with the treated water source. In another embodiment, the method of inhibiting corrosion of the metal containment surface includes applying the corrosion inhibitor composition to the metal containment surface or portion thereof wherein the metal containment surface is subsequently contacted with a water source.

In embodiments, the applying or adding may include dripping, pouring, spraying, pumping, injecting, or otherwise mixing the corrosion inhibitor composition with the metal containment surface or portion thereof, or to a water source that subsequently contacts a metal surface or portion thereof in the metal containment. In some embodiments, the applying is batchwise; in other embodiments the applying is continuous. In some embodiments, the method of corrosion inhibition further comprises storing the corrosion inhibitor composition in a container for a period of time prior to the applying.

In other embodiments, the corrosion inhibitor composition or treated water source may be applied at any location of an oil and gas well or midstream transport, storage, or distribution system that is, or may be susceptible to, corrosion from contact with a water source. The application of the corrosion inhibitor composition or treated water source may be manual or it may be automatic, for example, by using chemical injection pumps. In some embodiments, the corrosion inhibitor composition may be stored in a chemical storage tank and a chemical injection pump associated therewith may be used to introduce the corrosion inhibitor composition into the desired location of the operation. In any of the above applications, the corrosion inhibitor compositions may be injected continuously and/or in batches. The chemical injection pump(s) can be automatically or manually controlled to inject any amount of the corrosion inhibitor composition effective for inhibiting corrosion.

The present disclosure will now be further described with reference to the following non-limiting examples.

### EXAMPLES

### Example 1

Corrosion rates were measured by linear polarization resistance (LPR) using a three-electrode configuration consisting of three 1.72×0.25 inch 1080 carbon steel electrodes connected to a MS6200L benchtop LPR data logger (Metal Samples). Test solutions containing 0.2 w/w % of each polyethyleneamine alkoxylate to be evaluated were prepared by diluting 1.20 g of the alkoxylate to 600 g with DI water stock solution including 30 mM glacial acetic acid and 0.1 w/w % sodium chloride in a 1-l wide-mouth glass bottle. Once mixed, the test solutions were de-aerated by bubbling nitrogen gas for 30 minutes. The pH of each test solution was measured before and after de-aeration to confirm that no acetic acid had volatilized during the process. The de-aerated test solutions were then heated to 60° C. with stirring and measurements in mils per year (mpy) were taken over 5-minute periods in between 6-minute rest periods for a total of one reading every 11 minutes. Inputting the type of electrodes employed, LPR measurements provided mills per year (mpy) corrosion rates directly. Testing was conducted over a period of approximately 20 hours.

The electrodes were prepared by successive polishing with 160- (optional) 400- and 3000-mesh sanding paper to obtain smooth, pit-free surfaces. The polished electrodes were then cleaned with isopropyl alcohol and dried prior to being weighed and fitted to the three-electrode assembly. At the conclusion of each test, the electrodes were immersed in DI water and cleaned by sonication for 10-30 minutes to remove loose corroded metal. These were then dried and weighed to obtain mass loss percentages. Gloves were worn at all times when handling the electrodes so as not to transfer oils associated with skin contact. Test bottles were cleaned and rinsed with DI water and dried prior to testing.

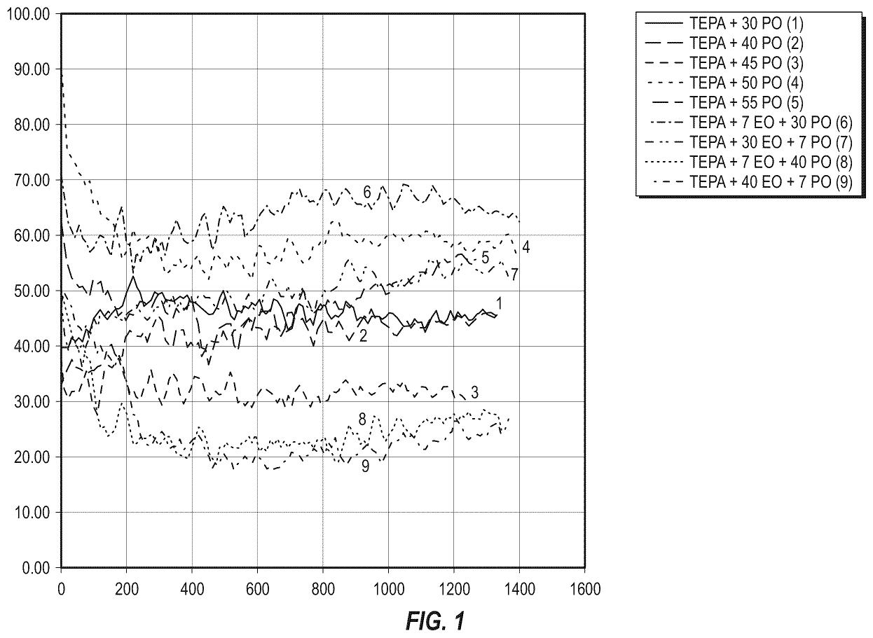

The tested polyethyleneamine alkoxylates having the number of moles of alkylene oxide are described below in Table 1. The corrosion rates over time are shown in FIG. 1. The pH values, electrode mass losses and average final corrosion rates are also described in Table 2.

TABLE 1
Chemical description of test substances.

| Alkoxylate | Description |
|---|---|
| 1 | TEPA + 30 PO |
| 2 | TEPA + 40 PO |
| 3 | TEPA + 45 PO |
| 4 | TEPA + 50 PO |
| 5 | TEPA + 55 PO |
| 6 | TEPA + 7 EO + 30 PO |
| 7 | TEPA + 30 PO + 7 EO |
| 8 | TEPA + 7 EO + 40 PO |
| 9 | TEPA + 40 PO + 7 EO |

(TEPA = tetraethylenepentamine; PO = propylene oxide; and EO = ethylene oxide)

TABLE 2
pH values of test solutions following de-aeration and testing,
electrode mass loss (%) and final corrosion rate (mpy).

| | | |
|---|---|---|
| pH | Electrode | Corrosion |

| | After De- | After | Mass Loss | Rate |
|---|---|---|---|---|
| Alkoxylate¹ | aeration | Testing | (%)² | (mpy)³ |
| 1(2) | 3.79 | 4.25 | 0.73 | 45.4 |
| 2 | 3.65 | 4.25 | 1.16 | 45.1 |
| 3(3) | 3.62 | 4.10 | 0.72 | 34.0 |
| 4(3) | 3.50 | 4.21 | 1.10 | 52.3 |
| 5(2) | 3.56 | 4.23 | 1.00 | 55.0 |
| 6 | 3.70 | 4.32 | 1.07 | 63.6 |
| 7 | 3.69 | 4.20 | 0.92 | 53.8 |
| 8(2) | 3.66 | 3.67 | 0.32 | 28.4 |
| 9 | 3.62 | 3.62 | 0.37 | 24.8 |

¹Values in parenthesis refer to the number of trials performed. For alkoxylates in which more than one trial was performed, average results are reported.
²Mass loss = 100 × (Wᵢ − W_{f})/Wᵢ where Wᵢ and W_{f} are the initial and final weights of the electrodes, respectively, measured to four places.
³Corrosion rates are reported as averages of the last 10 readings, representing the final 110 minutes of testing. Although high variability in the rates of corrosion was observed for several of the test solutions containing the respective polyethyleneamine alkoxylates within the first few hours of testing, notably less variability was observed in the last few hours, for which average values were reported in Table 2. Standard deviations for the polyethyleneamine alkoxylates for which multiple trials were performed were approximately 2-3 mpy. TEPA itself was tested as a control and yielded a corrosion rate of 88.4 mpy (data not shown), the highest rate recorded.

Lower corrosion rates appeared to correlate with increasing degree of propoxylation up to 45 moles (alkoxylate 3) and then drop with further increases (alkoxylates 4 and 5), possibly because the latter are less water soluble. For those alkoxylates containing both EO and PO blocks, alkoxylates 6 and 7 having the same number of EO and PO repeating units but in reverse order perform somewhat similarly. Alkoxylates 8 and 9 also performed similarly and appeared to be significantly more effective in inhibiting corrosion.

### Example 2

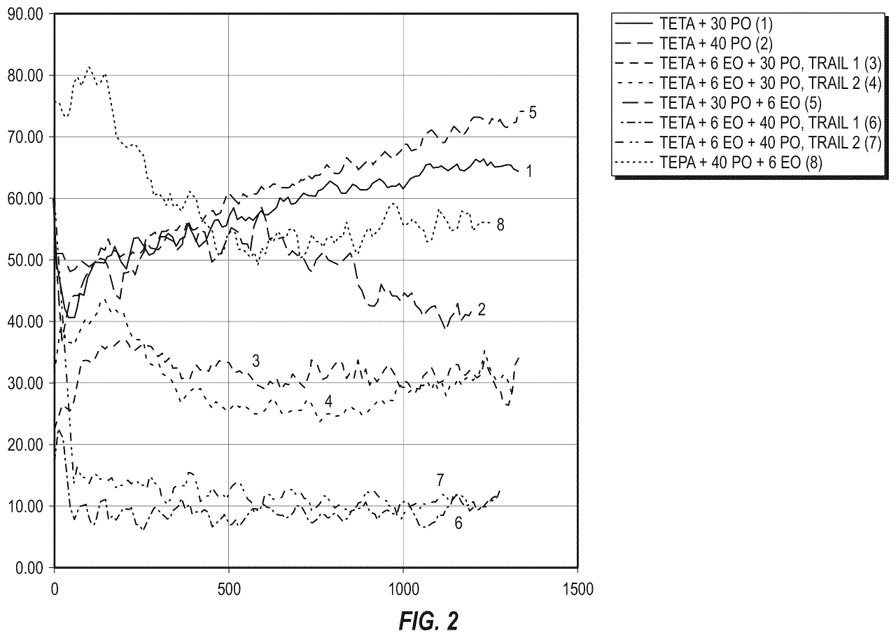

Example 1 was repeated with the inventive polyethyleneamine alkoxylates described in Table 3. The corrosion rate over time are shown in FIG. 2 and the pH values, electrode mass losses and average final corrosion rates are described in Table 4.

TABLE 3
Chemical description of test substances.

| Alkoxylate | Description |
|---|---|
| 1 | TETA + 30 PO |
| 2 | TETA + 40 PO |
| 3 | TETA + 6 EO + 30 PO |
| 4 | TETA + 30 PO + 6 EO |
| 5 | TETA + 6 EO + 40 PO |
| 6 | TETA + 40 PO + 6 EO |

(TETA = triethylenetetramine)

TABLE 4
pH values of test solutions following de-aeration and testing,
electrode mass loss (%) and final corrosion rate (mpy).

| | | |
|---|---|---|
| pH | Electrode | Corrosion |

| | After De- | After | Mass Loss | Rate |
|---|---|---|---|---|
| Alkoxylate | aeration | Testing | (%)¹ | (mpy)² |
| 1 | 3.76 | 4.52 | 1.26 | 65.3 |
| 2 | 3.59 | 4.12 | 0.86 | 40.8 |
| 3 | 3.66 | 3.96 | 0.41 | 30.3 |
| | 3.64 | 3.74 | 0.40 | 31.4 |
| 4 | 3.67 | 4.79 | 1.52 | 75.5 |
| 5 | 3.61 | 3.59 | 0.20 | 10.6 |
| | 3.60 | 3.50 | 0.24 | 10.4 |
| 6 | 3.40 | 4.28 | 0.89 | 56.1 |

¹Mass loss = 100 × (Wᵢ − W_{f})/Wᵢ where Wᵢ and W_{f} are the initial and final weights of the electrodes, respectively, measured to four places.
²Corrosion rates are reported as averages of the last 10 readings, representing the final 110 minutes of testing.

Alkoxylate 2 performed better than alkoxylate 1 and alkoxylate 5, containing a 40-PO block, performed better than alkoxylate 3, containing a 30-PO block. These trends are similar to those observed for the TEPA analogs. However, unlike the TEPA analogs in Example 1, inhibition performance depended heavily on the order of EO and PO. Alkoxylates 3 and 5, containing EO-PO blocks, performed significantly better than alkoxylates 4 and 6, containing PO-EO blocks of the same molar ratios. Notably, alkoxylate 5 with a final average corrosion rate of 10.5 mpy, performed notably better than TEPA+40 PO+7 EO, the best performer of the TEPA series, with a rate of 24.8 mpy.

1. A treated water source comprising a water source and a corrosion inhibitor composition comprising a polyethyleneamine alkoxylate having a general formula (I) 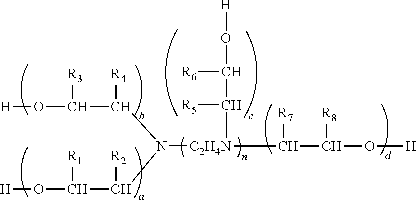
wherein R₁ and R₂ are each independently hydrogen, or methyl with the proviso that at least one of R₁ or R₂ is hydrogen and each R₁ and R₂ is independently selected in each —O—CHR₁—CHR₂— unit;
R₃ and R₄ are each independently hydrogen, or methyl with the proviso that at least one of R₃ or R₄ is hydrogen and each R₃ and R₄ is independently selected in each —O—CHR₃—CHR₄— unit;
R₅ and R₆ are each independently hydrogen, or methyl with the proviso that at least one of R₅ or R₆ is hydrogen and each R₅ and R₆ is independently selected in each —O—CHR₅—CHR₆— unit;
R₇ and R₈ are each independently hydrogen, or methyl with the proviso that at least one of R₇ or R₈ is hydrogen and each R₇ and R₈ is independently selected in each —O—CHR₅—CHR₆— unit;
a, b, c, and d are each independently integers on average of less than about 15 with the proviso that a+b+c+d is on average at least about 30 and less than about 49; and
n is an integer from about 1 to about 10.

2. The treated water source according to claim 1, wherein an amount of oxyethylene units present in the polyethyleneamine alkoxylate of formula (I) is at least about 1% by weight, based on the total weight of oxyethylene units and oxypropylene units.

3. The treated water source of claim 1, wherein an amount of oxypropylene units present in the polyethyleneamine alkoxylate of formula (I) is at least about 1% by weight, based on the total weight of oxyethylene units and oxypropylene units.

4. The treated water source of claim 1, wherein each of R₁-R₈ are hydrogen.

5. The treated water source of claim 1, wherein the respective groupings of R₁ and R₂, R₃ and R₄, R₅ and R₆, and R₇ and R₈ each include at least one methyl group.

6. The treated water source of claim 1, wherein the treated water source includes a total polyethyleneamine alkoxylate concentration, by weight, of at least about 50 ppm.

7. A corrosion inhibitor composition comprising (i) a polyethyleneamine alkoxylate having a general formula (I) 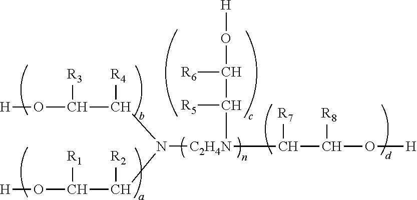
wherein R₁ and R₂ are each independently hydrogen, or methyl with the proviso that at least one of R₁ or R₂ is hydrogen and each R₁ and R₂ is independently selected in each —O—CHR₁—CHR₂— unit;
R₃ and R₄ are each independently hydrogen, or methyl with the proviso that at least one of R₃ or R₄ is hydrogen and each R₃ and R₄ is independently selected in each —O—CHR₃—CHR₄— unit;
R₅ and R₆ are each independently hydrogen, or methyl with the proviso that at least one of R₅ or R₆ is hydrogen and each R₅ and R₆ is independently selected in each —O—CHR₅—CHR₆— unit;
R₇ and R₈ are each independently hydrogen, or methyl with the proviso that at least one of R₇ or R₈ is hydrogen and each R₇ and R₈ is independently selected in each —O—CHR₅—CHR₆— unit
a, b, c, and d, are each independently integers on average of less than about 15 with the proviso that a+b+c+d is on average at least about 30 and less than about 49; and
n is an integer from about 1 to about 10 and (ii) at least one solvent, additive or a mixture thereof.

8. The corrosion inhibitor composition of claim 7, wherein the solvent comprises water, a C₁-C₆ alkanol, an alkoxyalkanol, a glycol, or a mixture thereof.

9. The corrosion inhibitor composition of claim 7, wherein the additive comprises a surfactant, pH-adjusting agent, oxygen scavenger, preservative, scale inhibitor, wetting agent, dispersant, binding agent, weighting agent, emulsion breaker, foamer/defoamer, buffer, water clarifier, salt, proppant particulates, diverting agent, fluid loss control additive, gas, nitrogen, carbon dioxide, surface modifying agent, tackifying agent, catalyst, clay control agent, biocide, friction reducer, bridging agent, flocculant, H₂S scavenger, CO₂ scavenger, lubricant, relative permeability modifier, resin, coating enhancement agent, filter cake removal agent, or a mixture thereof.

10. The corrosion inhibitor composition of claim 7, wherein the amount of polyethyleneamine alkoxylate present in the corrosion inhibitor composition is at least about 0.01% by weight and up to about 99.9% by weight, based on the total weight of the corrosion inhibitor composition.

11. A method of forming a treated water source comprising adding a corrosion inhibitor composition comprising a polyethyleneamine alkoxylate having a general formula (I) 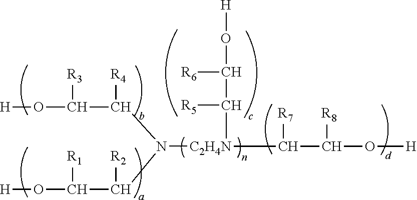
wherein R₁ and R₂ are each independently hydrogen, or methyl with the proviso that at least one of R₁ or R₂ is hydrogen and each R₁ and R₂ is independently selected in each —O—CHR₁—CHR₂— unit;
R₃ and R₄ are each independently hydrogen, or methyl with the proviso that at least one of R₃ or R₄ is hydrogen and each R₃ and R₄ is independently selected in each —O—CHR₃—CHR₄— unit;
R₅ and R₆ are each independently hydrogen, or methyl with the proviso that at least one of R₅ or R₆ is hydrogen and each R₅ and R₆ is independently selected in each —O—CHR₅—CHR₆— unit;
R₇ and R₈ are each independently hydrogen, or methyl with the proviso that at least one of R₇ or R₈ is hydrogen and each R₇ and R₈ is independently selected in each —O—CHR₅—CHR₆— unit;
a, b, c, and d are each independently integers on average of less than about 15 with the proviso that a+b+c+d is on average at least about 30 and less than about 49; and
n is an integer from about 1 to about 10 to a water source.

12-15. (canceled)

16. The method of claim 11, wherein the method further comprises contacting a metal containment surface or a portion thereof with the treated water source.

17. The method of claim 11, wherein the method comprises applying the corrosion inhibitor composition to a metal containment surface or a portion thereof, and wherein the metal containment surface or the portion thereof is subsequently contacted with the water source.

18. The method of claim 17, further comprising storing the corrosion inhibitor composition in a container for a period of time prior to the applying.
